(19) United States
(12) Patent Application Publication
(10) Pub. No.: US 2003/0051470 A1
(43) Pub. Date: Mar. 20, 2003

(54) Control system for hydraulic equipment attachments

(76) Inventor: David Maddock, Bloomington, IN (US)

Correspondence Address: David E. Novak, Woodard, Emhardt, Naughton, Moriarty and McNett, Bank One Center/Tower, 111 Monument Circle, Suite 3700, Indianapolis, IN, 46204-5137, US

(21) Appl. No.: 10/243,372

(22) Filed: Sep. 13, 2002

Related U.S. Application Data
(60) Provisional application No. 60/322,263, filed on Sep. 14, 2001.

(51) Int. Cl. F16D 31/00

(52) U.S. Cl. 60/368

(57) ABSTRACT

A control system for controlling hydraulic work attachments is provided. The system includes a hydraulic work attachment having an electronic information storage device capable of storing operational information of the attachment. When engaged with a work vehicle, this information is electronically transmitted to the vehicle's control computer so as to allow the computer to better control the work attachment. A control system for controlling multiple attachments having electronic storage devices and/or conventional work attachments is also provided.

This application claims priority to and incorporates by reference U.S. Provisional Application Serial No. 60/322,263 filed Sep. 14, 2001.

### FIELD OF THE INVENTION

The present invention relates generally to a control system for a hydraulically powered work apparatus, and more particularly to a control system which integrates the operating characteristics of a work attachment into the overall control of the system.

### BACKGROUND OF THE INVENTION

Work vehicles utilizing fluid powered work attachments are well known in the construction and excavating fields. With the development of the skid-steer loader in the 1950's, the use of hydraulic powered work attachments has expanded rapidly. These comparatively low-powered work vehicles were smaller and more affordable to users outside of the construction industry. Over time, new attachments such as scrapers, augers, and even snowblowers have been developed to supplement the traditional backhoe and bucket attachments. Today, these multi-application work vehicles can be found in places such as golf courses and farms in addition to construction sites. While new attachments for these vehicles have made them more useful for a wider variety of applications they have also created problems.

As the skid-steer loader market expanded the wide variety of loaders and hydraulically powered work attachments created problems. Different attachments have different capabilities and place different demands on the hydraulic system and engine of the work vehicle. If the hydraulic system pump is capable of only a single power setting, poor performance may result if this setting is too low for a particular attachment as the attachment becomes starved for power. If the power setting is too high for an attachment the hydraulic system and the attachment itself may be damaged during operation.

Systems which allow the operator to adjust the fluid pressure to a particular attachment have only partially addressed this problem. Such systems typically allow the operator to select a particular power setting or mode of operation when using an attachment. These systems may actually prevent the problem of an incorrect pressure for a particular attachment provided they are used correctly. One problem is that operators will simply leave the system at the highest power setting rather than taking the time to adjust it for each attachment. Another problem is that operators may incorrectly set the power level for a particular attachment. In either scenario, the same problems may result as in the case of a system having a single power setting.

The present invention is directed towards overcoming the problems set forth above.

### SUMMARY OF INVENTION

One embodiment of the present invention is a unique control system for a hydraulic work attachment in a work vehicle. The work attachment incorporates a memory chip which is in electrical connection with the control unit of the work vehicle. The memory chip contains operational information concerning the attachment such as the serial number of the attachment, the type of attachment, and the maximum fluid flow and pressure for the attachment. The control unit utilizes data from attachment memory chip to control the operating conditions of the hydraulic system and the work vehicle.

A further embodiment of the present invention pertains to a control system for hydraulic work attachments in a work vehicle having multiple attachments where each attachment incorporates a memory chip in electrical connection with the control unit of the work vehicle.

Yet another embodiment of the present invention pertains to a control system for hydraulic work attachments in a work vehicle having multiple attachments where at least one attachment incorporates a memory chip in electrical connection with the control unit of the work vehicle and at least one attachment is a standard attachment having no memory chip.

A further embodiment of the present invention provides for selection between predetermined operating modes for a hydraulic control system in a work vehicle.

Further objects, embodiments, forms, benefits, aspects, features and advantages of the present invention may be obtained from the description, drawings, and claims provided herein.

### BRIEF DESCRIPTION OF THE DRAWINGS

FIG. 1 is a schematic view of an embodiment of the present invention utilizing a single work attachment.

FIG. 2 is a schematic view of an embodiment of the present invention utilizing multiple work attachments.

### DESCRIPTION OF THE PREFERRED EMBODIMENT

For the purposes of promoting understanding of the principles of the invention, reference will now be made to the embodiment illustrated in the drawings and specific language will be used to describe the same. It will nevertheless be understood that no limitation of the scope of the invention is hereby intended and alterations and modifications in the illustrated device, and further applications of the principles of the present invention as illustrated herein being contemplated as would normally occur to one skilled in the art to which the invention relates.

The present invention relates to a hydraulic control system for a work vehicle having one or more hydraulically powered work attachments. In one embodiment of the present invention, the work vehicle is powered by an engine having 100 to 250 horsepower, although work vehicles having engines of other power ratings are also contemplated. The work vehicle body may be that of a skid-steer loader, a motor grader, a front-end loader, or any other form capable of engaging and using a variety of hydraulically powered work attachments. The work vehicle has at least one hydraulic and electrical attachment point for a work attachment according to the present invention.

A work attachment according to the present invention preferably incorporates an information storage device such as a computer or memory chip. This storage device contains operational information and characteristics for the particular work attachment including such things as the attachment's serial number, it's maximum operating fluid pressure and it's maximum operating fluid velocity. The present invention also contemplates storing other information about the work attachment on the storage device. The work attachment also includes a means for providing an electrical connection between the storage device and the control computer of the work vehicle in addition to standard hydraulic connections well known in the art. Typical work attachments include backhoes, loading buckets, augers, rotary cutting devices and scrapers but other types of work attachments modified according to the present invention are also contemplated.

When a work vehicle and attachment modified according to the present invention are used, the storage device on the work attachment transmits the operational information of the work attachment to the control computer of the work vehicle. The control computer then utilizes this information when calculating a response to a command by a user. For example, if the user issued a command to raise the attachment, the control computer would compare the operational parameters necessary to complete the desired function with the maximums for the particular attachment. If the issued raise command requires a fluid pressure greater than the maximum operating pressure for the particular attachment, the control computer scales back the command in order to perform the desired function without damaging the attachment. In another example, if the user issued a command to engage a rotary motor the control computer would compare the operational parameters necessary to complete the desired function with the maximums for the particular motor. If the issued engage command requires a fluid pressure greater than the maximum operating pressure for the particular motor, the control computer scales back the command by limiting the pump output either directly or through a valve located between the hydraulic pump and the motor.

The present invention also contemplates using the attachment storage device as a means for verifying the type and origin of a work attachment being used. The storage device may also contain a serial number unique to a particular attachment. Work vehicles not authorized to use a particular attachment refuse to operate once the control computer detects information from the attachment storage device. This not only prevents the possibly unsafe use of an attachment not designed for a particular work vehicle, but it also will curtail the use of stolen work attachments. If the vehicle control computer does not recognize the attachment storage device as authentic, the work vehicle will refuse to operate the attachment.

Yet another embodiment of the present invention contemplates a work vehicle having a plurality of hydraulic and electrical attachment points for work attachments. A typical work vehicle may have hydraulic and electrical attachment points for two work attachments according to the present invention and one hydraulic attachment point for a work attachment lacking a storage device well known in the art. Other work vehicles having various combinations of appropriate attachment points for work attachments modified according to the present invention and standard, unmodified work attachments are also contemplated. In another embodiment of the present invention, the electrical attachment point corresponding to a particular hydraulic attachment point may be disabled so as to allow the user to attach and operate a conventional hydraulic work attachment. This may be accomplished, for example, by the use of a bypass switch which allows the vehicle control computer to recognize when a standard work attachment is engaged with a particular hydraulic attachment point and adjust the hydraulic fluid operational characteristics to standard conditions accordingly.

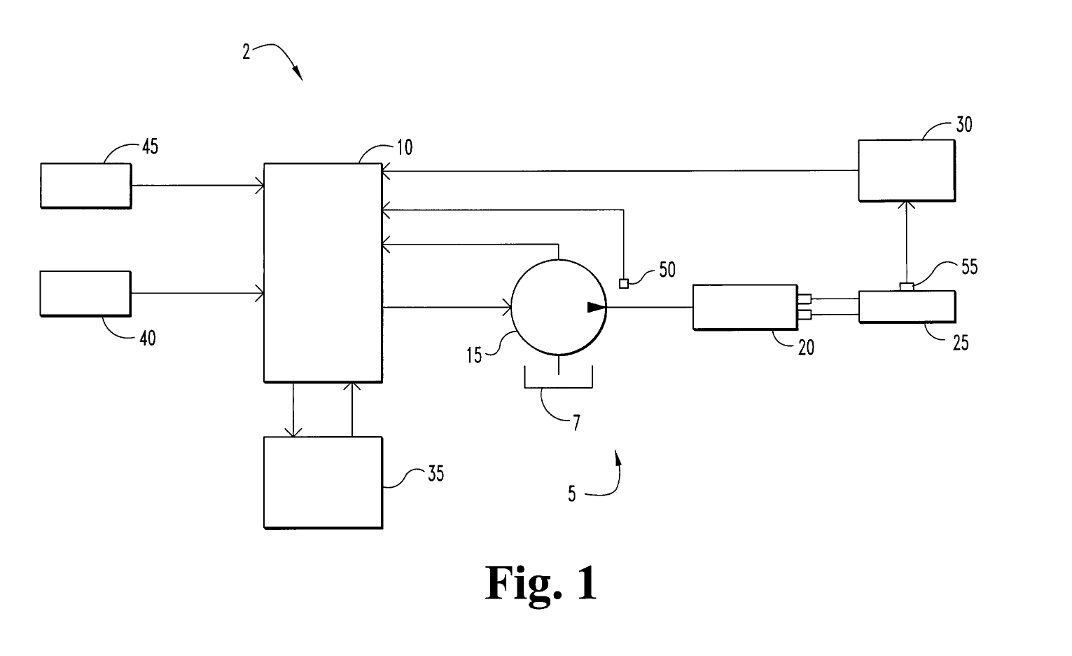

The embodiment of the present invention as shown in FIG. 1 illustrates the work attachment control system 2 of a work vehicle such as a hydraulic excavator or loader (not shown). The fluid system 5 of the work vehicle includes a power plant 35, typically a diesel or gasoline powered engine. The power plant 35 drives a variable displacement pump 15 which delivers fluid from a fluid reservoir 7 through a control valve 20 to a work attachment 25.

The control valve 20 is of a type commonly used in the art having a spool or stem for controlling the fluid delivered to the work attachment 25. Suitable control valves may include closed center pressure compensated valves or open center non-pressure compensated valves. The valve is capable of electronic actuation such that the fluid flow through the valve may be controlled by electronic signals sent to the valve. A pilot valve (not shown) may also be incorporated between a pilot pump (not shown) and the control valve 20, but the present invention is not limited to the use of pilot valves. Direct actuating elements may also be used in place of pilot valves.

A controller computer 10 delivers an electronic signal to proportionally displace the valve stem thereby regulating fluid flow from the variable displacement pump 15 to the work attachment 25. At least one user controller 45 such as an electronic joystick or lever is connected electronically connected to the controller computer 10. Operation of the user controller 45 by the user generates a demand signal corresponding to a desired operation. This demand signal indicating the desired fluid flow to the work attachment 25 is transmitted electronically to the controller computer 10.

Information is also transmitted to the controller computer 10 by the attachment control chip 30 located on the work attachment 25. An electrical connection between the attachment control chip 30 and the controller computer 10 is provided preferably near the hydraulic connection between the work attachment 25 and the hydraulic system 5 of the work vehicle. The attachment control chip 30 transmits information about the attachment 25 to the controller computer 10. Transmitted information may include, but is not limited to, the attachment's serial number, the type of attachment, available commands for the attachment, and the maximum pressure and rate of fluid flow for the attachment.

In yet another embodiment, an attachment operation sensor 55 may be used in addition to the attachment control chip 30. An attachment operation sensor 55 as is widely known in the art may collect continual operational information such as the attachment's speed, load, operational temperature and position and transmit it to the controller computer 10. This information may be transmitted to the controller computer 10 via the attachment control chip 30. Alternatively, the information from the attachment operation sensor 55 may be transmitted directly to the controller computer 10 by means of a direct electronic connection which bypasses the attachment control chip 30.

Additional information is provided to the controller computer 10 from the power plant 35 through a speed sensing device (not shown) well know in the art. Any device which delivers the actual speed of the power plant to the controller computer 10 is suitable.

Information concerning operating conditions of the pump 15 may be transmitted to the controller computer 10 by any means known in the art. Additionally, the output pressure of the pump 15 may be transmitted to the controller computer 10 by a pump output sensor 50. The pump output sensor 50 may include any mechanical or electronic detecting means as is known in the art.

The controller computer 10 may also receive input from an input device 40. A wide variety of input devices 40 are contemplated by the present invention. One such contemplated device is a work mode selection device. Such a device may include a dial having a plurality of discrete settings, each setting corresponding to a predetermined work mode (e.g. load, heavy digging, etc.) which produces a corresponding electrical signal transmitted to the controller computer 10 when a particular work mode is selected. Another contemplated input device includes a keypad having a plurality of keys. Each key would correspond to a predetermined work mode which produces a corresponding electrical signal transmitted to the controller computer 10 when a particular work mode is selected. Such work mode selection devices are well known in the prior art.

Another input device 40 contemplated by the present invention is a keyboard or computer. Such an input device may be used to alter the programming of the controller computer 10 as new work attachments are designed for a particular work vehicle or new uses are designed for a particular work attachment. It is contemplated that this type of input device 40 may be detachable from the controller computer 10 once the desired changes have been made.

The controller computer 10 is preferably a microprocessor based controller as is widely known in the art. Programming may be stored in an on board system memory which may include random access memory or read only memory as desired. The programming may be altered or updated by the use of an input device 40 as previously described.

When a work vehicle incorporating the present invention is used, a signal from the attachment control chip 30 is transmitted to the controller computer 10. This signal preferably indicates the maximum operating fluid pressure and maximum operating fluid velocity of the corresponding work attachment 25. It is also contemplated that the signal may transmit additional information to the controller computer 10 such as the type of attachment being used, available commands for an attachment, and the attachment's serial number.

When a user issues a command for a desired function through the user controller 45, the controller computer 10 receives the signal and calculates the required fluid flow rate and pressure to accomplish the desired task. The controller computer 10 will consider information from an input device 40 such as a mode selector if such a device is being utilized. The controller computer considers information provided by the attachment control chip 30 to prevent exceeding the operational tolerances of a particular attachment when calculating a response to the issued command. If a user command requires a fluid pressure or velocity which exceeds the maximum operating specifications of a particular attachment, the controller computer 10 will correspondingly scale back the requested action to remain in within the operational tolerances of the attachment.

The controller computer 10 may also monitor the operating speed of the power plant 35. The controller computer 10 may issue a command to the power plant 35 to increase output if the current output is too low to execute the desired command. Once a response has been calculated, the controller computer 10 issues commands to the pump 15 and the control valve 20 to cause the work attachment 25 to perform the desired function. Operating conditions of the power plant 35, the pump 15 (directly or via a pump output sensor 50), and the work attachment via an attachment operation sensor 55 may be monitored by the controller computer 10 during performance of the desired operation. The controller computer 10 may issue additional commands if operational conditions change during the performance of the desired function.

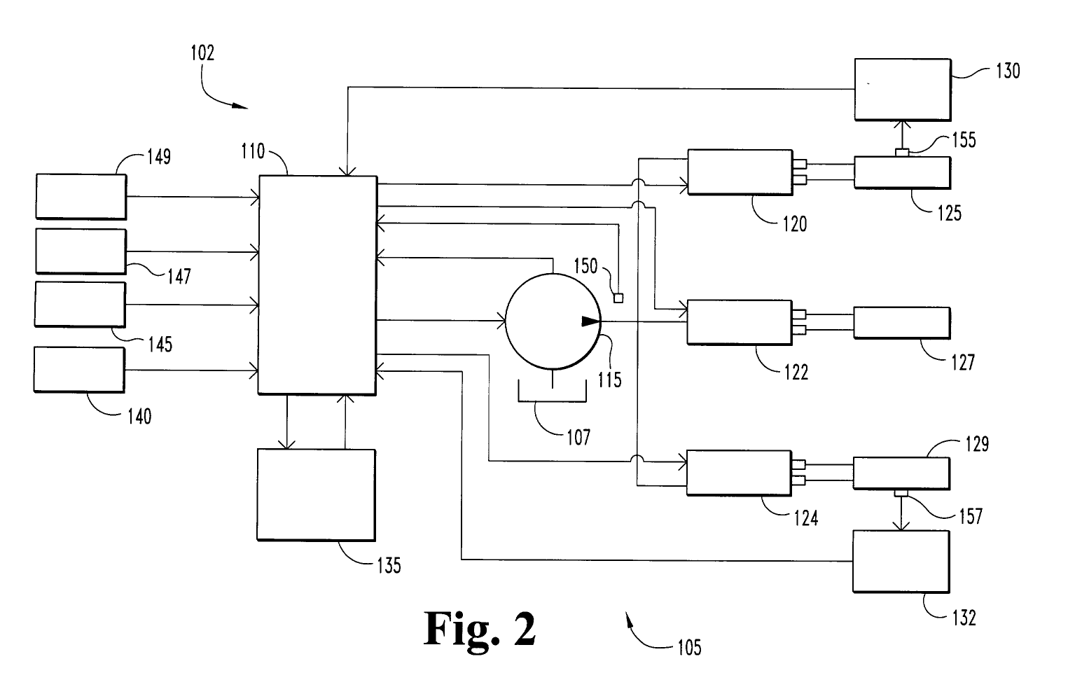

An alternative embodiment of the present invention depicted in FIG. 2 shows the work attachment control system 102 of a work vehicle having multiple work attachments 125, 127, 129. The embodiment depicted in FIG. 2 shows a work vehicle utilizing two attachments having attachment control chips 130, 132 according to the present invention as well as one attachment 127 as known in the art having no such control chip. This configuration is for illustrative purposes only and the present invention also contemplates additional configurations of attachments both with and without control chips according to the present invention.

The fluid system 105 of this embodiment utilizes a single variable displacement pump 115 with a fluid reservoir 107 as shown. The present invention also contemplates fluid systems 105 incorporating multiple variable displacement pumps. The work attachment control system 102 incorporates multiple user controllers 145, 147, 149 and multiple control valves 120, 122, 124 corresponding to a respective work attachment 125, 127, 129.

Operation of a work vehicle according to the embodiment of the present invention as shown in FIG. 2 is substantially similar to that of the embodiment depicted in FIG. 1. The controller computer 110 in an embodiment of the present invention incorporating multiple work attachments must also consider the demand placed on the power plant 135 and pump 115 when a user simultaneously issues multiple commands using the user controllers 145, 147, 149. In formulating a response, the controller computer still considers information from the power plant 135, the pump 115 (directly or via a pump output sensor 150), and the work attachments via any attachment operation sensors 155, 157. The controller computer 110 may also consider any input from an input device 140 such as a mode selector if any such device is present before issuing commands to the power plant 135, the pump 115, and the control valves 120, 122, 124 as necessary to accomplish the desired tasks.

While the invention has been illustrated and described in detail in the drawings and foregoing description, the same is to be considered as illustrative and not restrictive in character, it being understood that only the preferred embodiment has been shown and described and that all changes, modifications and equivalents that come within the spirit of the inventions disclosed are desired to be protected. The articles “a”, “an”, “said” and “the” are not limited to a singular element, and include one or more such element.

What is claimed is:

1. An electronic hydraulic control system for a construction vehicle having a work attachment control computer, at least one hydraulic pump and at least one command input device comprising: at least one hydraulic work attachment having a memory device containing operational characteristics of said at least one work attachment electronically connected to said control computer such that when an operation is requested using said at least one command input device said control computer determines whether the hydraulic fluid conditions required to perform said operation are within said operational characteristics and adjusts the output of said at least one hydraulic pump if the hydraulic fluid conditions required to perform said operation fall outside said operational characteristics.

2. The control system of claim 1 wherein said operational information includes the maximum operational hydraulic pressure for said at least one work attachment.

3. The control system of claim 1 wherein said operational information includes the maximum fluid flow rate for said at least one work attachment.

4. A method for controlling a hydraulically powered work attachment comprising:
providing a work vehicle having a control computer, at least one hydraulic pump and at least one command input device;
providing at least one hydraulic work attachment having a memory device containing operational characteristics of said work attachment;
transmitting said operational characteristics electronically from said memory device to said control computer;
accepting a command to perform an operation with said at least one work attachment from said at least one command input device;
determining whether the hydraulic fluid conditions required to perform said operation are within said operational characteristics;
adjusting the output of said at least one hydraulic pump if the hydraulic fluid conditions required to perform said operation fall outside said operational characteristics; and
performing said operation.

5. The method of claim 1 wherein said transmitting step includes the step of transmitting the maximum operational hydraulic pressure of said at least one work attachment.

6. The method of claim 1 wherein said transmitting step includes the step of transmitting the maximum fluid flow rate of said at least one work attachment.
